(19) United States
(12) Patent Application Publication
(10) Pub. No.: US 2026/0134264 A1
(43) Pub. Date: May 14, 2026

(54) System, Computer-Implemented Method, and Computer Readable Media for Using Generative Recommenders to Determine Propensity Towards or Probability of Actions Being Taken

(71) Applicant: Shopify Inc., Ottawa (CA)

(72) Inventors: Gabrielle FORGIONE, Charleston, SC (US); Come CARQUEX, Stoney Creek (CA)

(73) Assignee: Shopify Inc., Ottawa, ON (CA)

(21) Appl. No.: 18/999,217

(22) Filed: Dec. 23, 2024

Related U.S. Application Data
(60) Provisional application No. 63/718,177, filed on Nov. 8, 2024.

(51) Int. Cl. G06N 3/0475; G06N 3/047

(52) U.S. Cl. CPC G06N 3/0475; G06N 3/047

(57) ABSTRACT

A system and method for using a generative recommender to determine a propensity towards or probability of actions being taken. The method includes providing a sequence of events to a generative recommender and obtaining an output from the generative recommender. The method also includes using the output and a model to generate a result, the model having been trained to determine the propensity towards, or probability of, an action occurring following the sequence of events as processed by the generative recommender.

### CROSS-REFERENCE TO RELATED APPLICATION(S)

This application claims priority to U.S. Provisional Application No. 63/718,177 filed on Nov. 8, 2024, the entire contents of which are incorporated herein by reference.

### TECHNICAL FIELD

The following generally relates to using generative recommenders, in particular, to using generative recommenders to determine propensity towards or probability of actions being taken.

### BACKGROUND

Various systems generate event data associated with actions, activities, inputs, etc. Historical event data may be used to train models to make predictions and such predictions may be used, for example, to make recommendations. In an example, a sequence of events may be used to predict the next event. This is similar to how large language models (LLMs) accept a sequence of text (tokens) as an input and generate further text.

### BRIEF DESCRIPTION OF THE DRAWINGS

Embodiments will now be described with reference to the appended drawings wherein:

FIG. 1a is an example of a computing environment in which a propensity engine is utilized by an application at a server device.

FIG. 1b is an example of a computing environment in which a propensity engine is utilized by an application at a client device.

FIG. 2 illustrates an example of a configuration for a propensity engine.

FIG. 3 illustrates a Hierarchical Sequential Transduction Unit (HSTU) generative recommender utilized by a propensity engine, configured to utilize an event stream associated with an application.

FIG. 4 illustrates a configuration for training an HSTU model.

FIG. 5 illustrates an HSTU-based encoder for generative recommendations.

FIG. 6 illustrates a side feature embedding process.

FIG. 7 is an example of a computing device operable to communicate in the computing environment.

FIG. 8 is a flow chart illustrating example operations performed in using a generative recommender to determine a propensity towards or probability of actions being taken.

FIG. 9 is a flow chart illustrating example operations performed in generating combined embeddings using side features.

FIG. 10 is a flow chart illustrating example operations performed in training a generative recommender using combined embeddings.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

There may be an interest in making predictions based on event data where the predictions go beyond, or are more insightful than, predicting the next event. Predicting the next event may be performed using a model that has been trained to generate recommendations based on events. However, this may not go far enough to enable an entity to predict the likelihood or probability of an action being taken or detecting a propensity towards taking that action, let alone whether the action may be taken within a period of time.

Examples of actions for which the propensity towards, or probability of, the action being taken is of interest, include product adoption, user engagement with a service, subscriptions, renewals, unsubscribing, etc.

In past attempts, techniques such as independent random forest models have been used to predict product adoption propensity given features at a point in time. In this case, some features include event interactions but are aggregated into counts or Boolean features.

It has been recognized that a consolidated model that considers historical interactions as sequences, regardless of product type, may improve a system's ability to predict actions being taken, such as adoptions. This observation may apply to predicting the propensity towards, or probability of, other actions being taken.

To create a system that can predict the propensity towards or probability of an action being taken, a recommendation system may be leveraged and enhanced as discussed below. Generative recommendation (GR) systems are particularly suitable, for example, using HSTUs proposed in a paper entitled: “Actions Speak Louder than Words: Trillion-Parameter Sequential Transducers for Generative Recommendations” (Zhai, Jiaqi et al.—accessible at https://arxiv.org/pdf/2402.17152v), the contents of which are incorporated herein by reference in their entirety.

The proposed system may include two components, modules, or stages that may be used with a GR system such as an HSTU-based transformer, either alone or in combination, to enhance the GRs for use cases such as predicting the propensity or probability of an action occurring, e.g., in a particular period of time.

The first component enhances the event feature embeddings generated from the input event sequence. The event feature embeddings may be combined (e.g., concatenated) with “side-features”, which provide additional content, themes, or context related to the event. The side feature embeddings may be used in both training the model and input to inference.

The second component replaces the next token prediction layer (i.e., the last layer of the HSTU) with a model (e.g., multilayer perceptron (MLP) and Sigmoid) that is trained for the desired outcome, such as to estimate the propensity towards, or probability of, an action being taken (e.g., in product adoption).

In one aspect, there is provided a computer-implemented method, comprising providing a sequence of events to a generative recommender; obtaining an output from the generative recommender; and using the output and a model to generate a result, the model having been trained to determine a propensity towards, or probability of, an action occurring following the sequence of events as processed by the generative recommender.

In certain example embodiments, the generative recommender comprises an HSTU.

In certain example embodiments, the HSTU comprises a plurality of sequential transducers and an attention mechanism.

In certain example embodiments, the HSTU comprises multiple layers connected by residual connectors.

In certain example embodiments, the multiple layers are identical.

In certain example embodiments, the sequential transducers comprise a pointwise projection sub-layer, a spatial aggregation sub-layer, and a pointwise transformation sub-layer, and wherein the output is obtained from the pointwise transformation sub-layer of a penultimate layer of the plurality of layers.

In certain example embodiments, an output obtained from a final layer of the plurality of layers is used to predict a next event.

In certain example embodiments, the model is an MLP.

In certain example embodiments, the MLP is trained to predict the propensity towards, or probability of, the action based on the output obtained from a penultimate layer of the generative recommender.

In certain example embodiments, embeddings for the events in the sequence of events are combined with embeddings for side features associated with the events.

In certain example embodiments, the method further includes using the combined embeddings as the sequence of events.

In certain example embodiments, the side features are subjected to a linear transformation and combined with the embeddings for the events.

In certain example embodiments, transformed side features are concatenated with the embeddings for the events, to create user embeddings.

In certain example embodiments, the side features are embedded with the embeddings for the events, using fields in a sequence of bits associated with the event.

In certain example embodiments, the side features are used in training the generative recommender.

In certain example embodiments, the side features embed a type of event to distinguish between different types of a same event.

In certain example embodiments, the method further includes presenting the propensity towards, or probability of the action being taken.

In certain example embodiments, the propensity towards, or probability of, the action being taken is associated with a window of time.

In certain example embodiments, the model presents the propensity towards, or probability of, the action occurring within the window of time.

In another aspect, there is provided a computer system comprising a processor and a memory. The memory stores processor executable instructions that, when executed by the processor, cause the computer system to provide a sequence of events to a generative recommender; obtain an output from the generative recommender; and use the output and a model to generate a result, the model having been trained to determine a propensity towards, or probability of, an action occurring following the sequence of events as processed by the generative recommender.

In another aspect, there is provided a computer-readable medium storing processor executable instructions that, when executed by a processor of a computer system, cause the computer system to provide a sequence of events to a generative recommender; obtain an output from the generative recommender; and use the output and a model to generate a result, the model having been trained to determine a propensity towards, or probability of, an action occurring following the sequence of events as processed by the generative recommender.

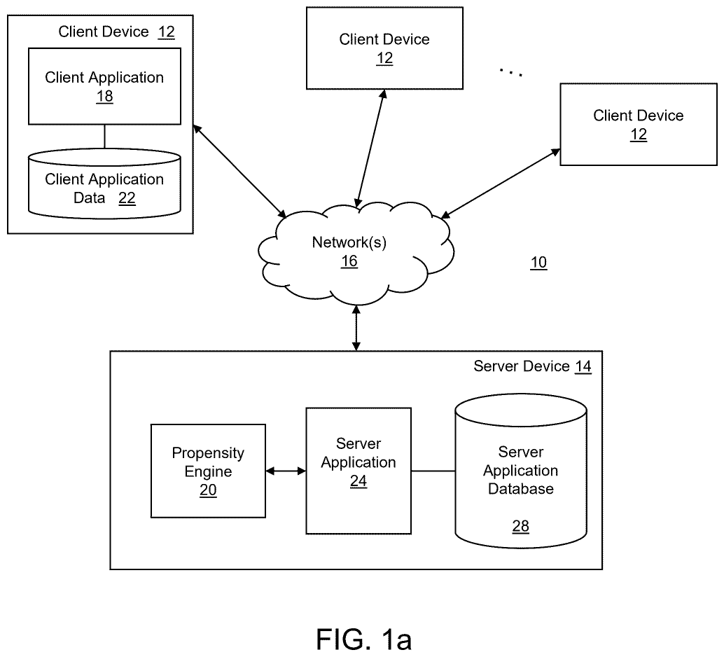

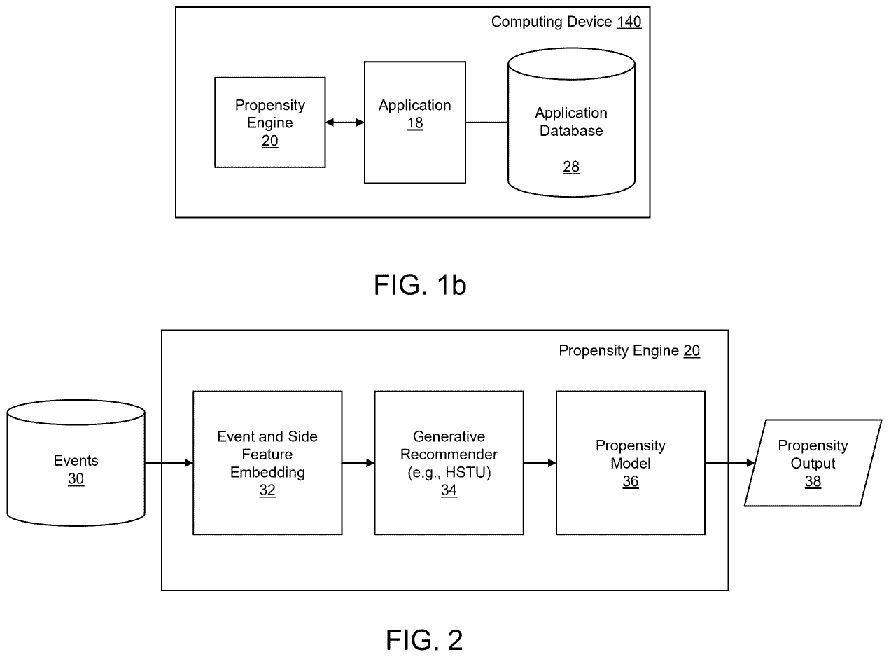

Turning now to the figures, FIG. 1a illustrates an example of a computing environment 10. The computing environment 10 in this example includes one or more client devices 12 that communicate with a remote server device 14 via one or more networks 16. In the example shown in FIG. 1a, a number of client devices 12 are capable of communicating with the remote server device 14, which number may vary based on the computing environment 10. Any one or more of such client devices 12 may operate as described herein to communicate with to exchange data and information with the remote server device 14. The client device 12 may include a client application 18. The client application 18 may include or have access to client application data 22.

The client application 18 may communicate with a server application 24 hosted by the server device 14. The server application 24 may include or have access to a server application database 28, which includes data used by the server application 24. This may include accessing or storing data and information on behalf of the client application 18 in configurations where the client application 18 operates in conjunction with the server application 24.

The server application 24 includes or has access to a propensity engine 20. The propensity engine 20 includes functionality to determine the propensity towards, or probability of, an action being taken. The propensity engine 20 may leverage GRs to train a model and infer from that model the propensity towards or probability of the action being taken. The propensity engine 20 may additionally utilize side features to enhance the embeddings associated with events that are used in determining the generative recommendations. In the configuration shown in FIG. 1a, the propensity engine 20 is used in a client-server relationship, wherein the client application 18 may utilize the propensity engine 20 via the server application 24. Moreover, the server application 24 and the propensity engine 20 may serve multiple client devices 12 as illustrated in FIG. 1a.

FIG. 1b illustrates another configuration in which the propensity engine 20 is a local tool utilized by an application 18 on a computing device 140. In this configuration, the application 18 includes or has access to an application database 28 and may utilize the propensity engine 20 locally, without communicating with a server device 14 or other remote resource or service. As such, the propensity engine 20 may be deployed in different configurations depending on the application 18, 24, the type of computing device 140 and the nature of the computing environment 10.

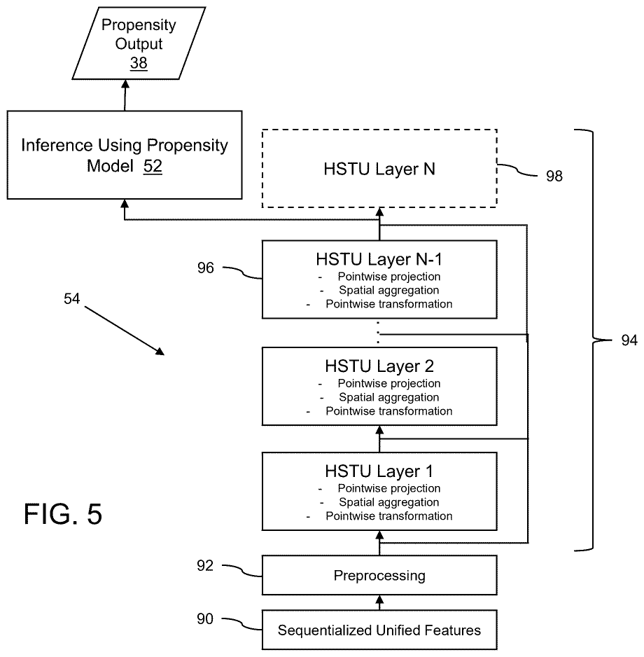

The client device 12 and/or remote server device 14, may be implemented using one or more computing devices 140 (e.g., see FIG. 1b and FIG. 5 described below) or computing systems. Such computing devices 140 or computing systems may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a portable terminal (e.g., POS device), a virtual reality device, an augmented reality device, etc.

The one or more networks 16 shown in FIG. 1a may include a telephone network, cellular, and/or data communication network to connect different types of client- and/or server-type devices. For example, the communication network 16 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

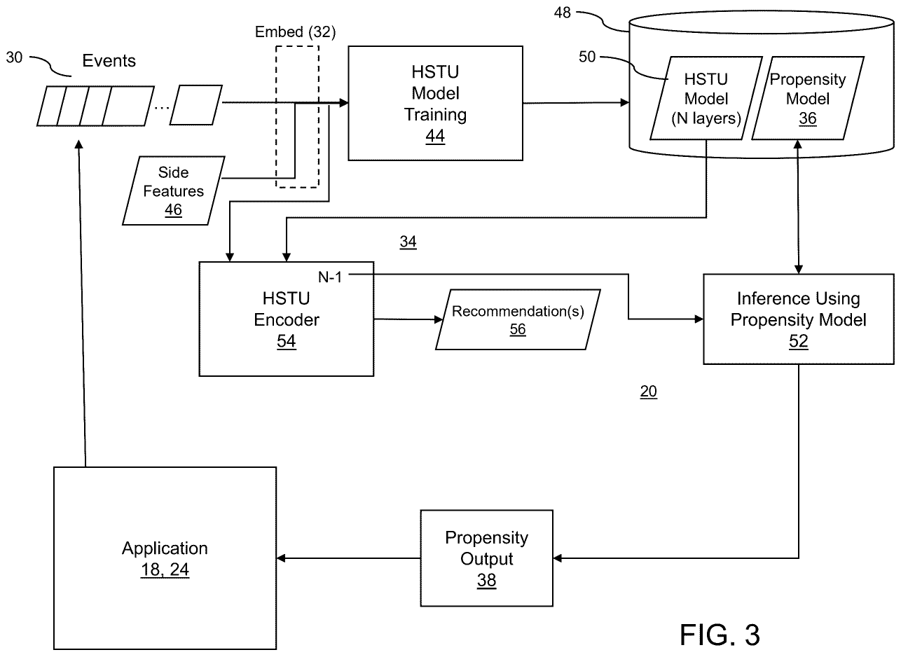

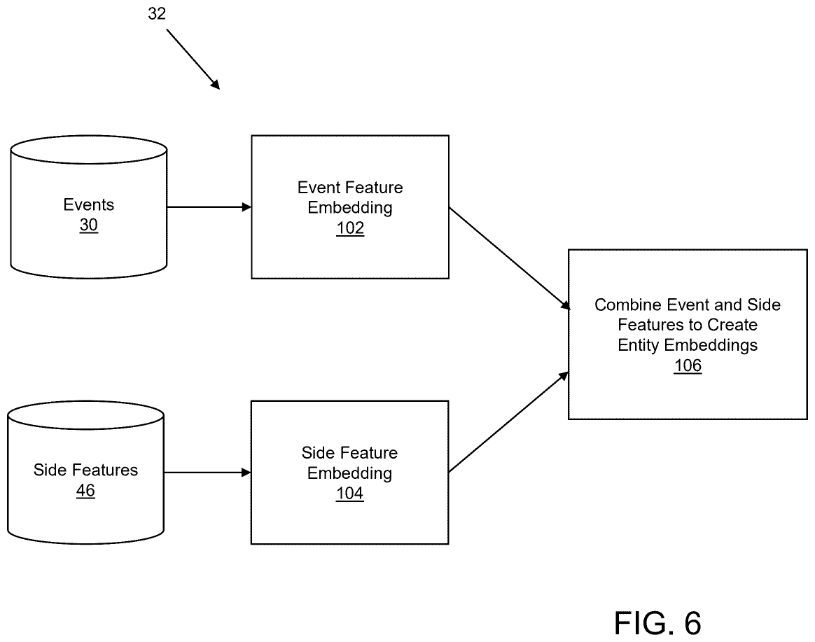

Further detail concerning a configuration for the propensity engine 20 is shown in FIG. 2. The propensity engine 20 may receive a set, collection, group, stream or other sequence of events 30 as an input. Herein the terms “event”, “events”, “event stream”, “stream of events”, “set of events”, “sequence of events”, etc. may be commonly referred to using reference numeral “30”. The sequence of events 30 may include a number of events 30 that are associated with an application 18, 24, or other software program (e.g., see also FIG. 3). The propensity engine 20 may apply event and side feature embedding 32 to enhance the event feature embeddings generated from the sequence of events 30. The event feature embeddings may be combined (e.g., concatenated) with side-features 46 (e.g., see also FIG. 6) to provide additional content, themes, or context related to the event 30. The side feature embeddings 32 may be used in both training a model and input to making an inference using that model.

The propensity engine 20 may also utilize a generative recommender 34, such as an HSTU. The HSTU architecture may be used to adapt transformers to perform generative recommendations. The HSTU architecture provides pointwise aggregated attention, which uses a pointwise normalization mechanism instead of softmax normalization. This may make the architecture suitable for non-stationary vocabularies in streaming settings. The pointwise aggregated attention may be capable of capturing the intensity of user preferences and engagements effectively.

An output obtained from a layer of the generative recommender 34 may be used for training or inference with a propensity model 36 to determine a propensity output 38 indicative of the propensity towards, or probability of, an action being taken. It has been found that the output of the penultimate layer of the generative recommender 34, based on the events 30, may be used to train and infer a model such as an MLP (e.g., propensity model 36) to determine the propensity towards or probability of an action being taken as the output 38. In this way, the data on which model is to be trained is determined for the model designer or engineer, thus accelerating the process to obtain a model (e.g., propensity model 36) that may generative the desired output 38.

Referring now to FIG. 3, an example of a configuration for the propensity model 20 and the generative recommender 34 is shown. In this configuration, an application 18, 24 (e.g., a client application 18 and/or server application 24) may include or generate a stream or sequence of events 30. The events 30 may be obtained from a database or other memory (e.g., as illustrated in FIG. 2) or obtained in real-time as events 30 occur. For training purposes, the events 30 may be stored and used in a process of HSTU model training 44. This generates an HSTU model 50 with N layers. The events 30 may be combined with side features 46 to generate event and side feature embeddings 32. This may be done for training 44 and for inference using an HSTU encoder 54. The generative recommender 34 or propensity engine 20 may include a memory 48 to store the HSTU model 50 and the propensity model 36.

The HSTU encoder 54 may use the HSTU model 50 and the sequence of events 30 and/or a sequence of side feature-embedded events 30 to generate one or more recommendations 56, which provide a next event prediction. In this configuration, the output of the penultimate layer (i.e., layer N−1) of the HSTU model 50 is used to make an inference using the propensity model 36 at block 52. From this inference, the engine 20 may present, display, or otherwise provide the propensity output 38. FIG. 3 illustrates the propensity output 38 being provided to the application 18, 24, however, it can be appreciated that the propensity output 38 may, additionally or alternatively, be provided to other applications, tools, functions, services, entities/users, etc.

The HSTU-based generative recommender 34 leverages sparsity with an efficient kernel that can transform attention computation into grouped general matrix multiplications (GEMMs). The HSTU recommender 34 may algorithmically increase the sparsity of user history sequences via stochastic length (SL), reducing computational cost without degrading model quality. SL selects input sequences to maintain high sparsity and reduce training costs, which may outperform existing length extrapolation techniques, making SL highly effective for large-scale recommendation systems. These and other features have been found to lead to memory and other efficiencies in training and inference operations.

As illustrated in the above-noted paper, the HSTU model 50 utilizes a configuration that represents categorical features as auxiliary events in a time series. The approach described in the paper sequentializes and unifies the heterogeneous feature space in deep learning recommendation models (DLRMs), with a new approach approximating the full DLRM feature space as sequence length tends to infinity. This enables the reformulation of the main recommendation problems, ranking and retrieval, as pure sequential transduction tasks in GRs. This can further enable model training to be done in a sequential, generative fashion, which permits training on orders of magnitude more data with the same amount of compute.

The HSTU architecture may also be used to address computational cost challenges throughout both training and inference. HSTU modifies the attention mechanism for large, non-stationary vocabulary, and exploits characteristics of recommendation datasets to achieve performance improvements.

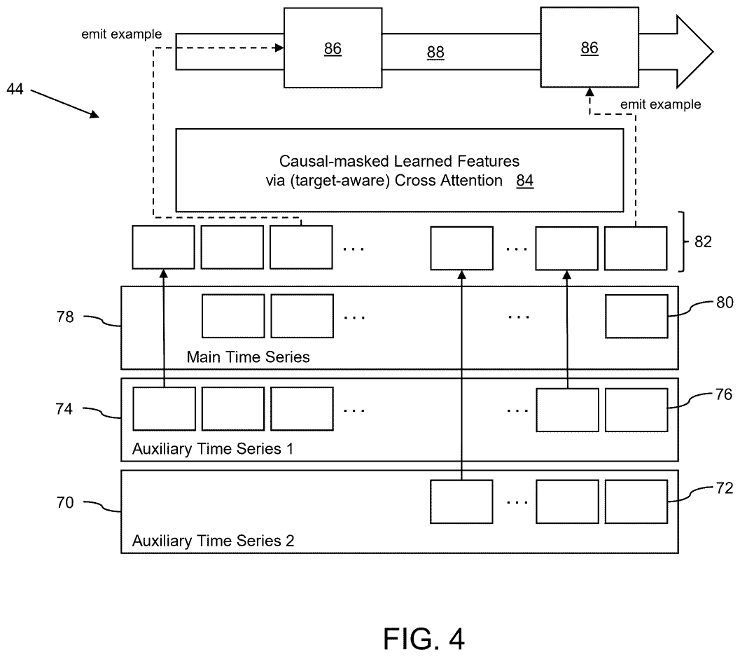

FIG. 4 illustrates recommendation as sequential transduction tasks using an HSTU architecture. Whereas modern DLRM models are typically trained with a vast number of categorical (sparse) and numerical (dense) features. In GRs, these features are consolidated and encoded into a single unified time series, as shown in FIG. 4.

Examples of such categorical/sparse features include items that a user liked, categories of other entities that the user is following, languages, communities or locations associated with requests, etc. The features are sequentialized by first selecting the longest time series, e.g., by merging the features that represent items the user engaged with as the main time series. The remaining features may be time series that slowly change over time, such as demographics or followed entities. These time series may be compressed by keeping the earliest entry per consecutive segment and then merge the results into the main time series. Given that such time series change slowly, the illustrated approach should not significantly increase the overall sequence length.

Examples of numerical/dense features include weighted and decayed counters, ratios, etc. For instance, one feature may represent click through rates for a given topic. When compared to categorical features, the numerical/dense features are expected to change more frequently, e.g., sometimes with each user/item interaction. As such, the numerical/dense features are not fully sequentialized due to computation and storage concerns. However, since the categorical/sparse features over which the aggregations are performed are already sequentialized and encoded in GRs, the numerical features can be removed in GRs when having a sufficiently expressive sequential transduction architecture coupled with a target-aware formulation that can meaningfully capture numerical features.

As illustrated in FIG. 4, when given a list of tokens ordered chronologically, having the time when the tokens are observed, and other metadata that may be available, a sequential transduction task maps the input sequences to the output tokens subject to a mask sequence. The input tokens come from a vocabulary that may be dynamic and non-stationary. At scale, the generative recommender 34 may be trained in a streaming setup, where each example is processed sequentially as it becomes available. To train sequential transduction models over long sequences in a way that is scalable, the HSTU training architecture may use generative training to reduce the computational complexity as shown in the training pipeline 88 in FIG. 4. As shown in FIG. 4, features 72 in a second auxiliary time series 70 and features 76 in a first auxiliary time series 74 are interspersed with features 80 of a main time series 78 to create a merged and sequentialized stream 82. The stream 82 is subjected to a process 84 for determining causal-masked learned features via target-aware cross attention. Examples 86 are emitted to the training pipeline 88 to train the HSTU model 50.

FIG. 5 illustrates an example of an HSTU encoder 54. In this configuration, the sequence of events 30, which may include the side feature embeddings 32, are input as sequentialized unified features 90, which are subject to preprocessing. The preprocessed features are provided to the first layer of a number of layers 94 of the HSTU, denoted “HSTU Layer 1” in FIG. 5. Each layer is connected by residual connectors and includes steps of pointwise projection (see equation (1) below), spatial aggregation (see equation (2) below), and pointwise transformation (see equation (3) below).

$$U ( X ) , V ( X ) , Q ( X ) , K ( X ) = Split ( {∅}_{1} ( {f}_{1} ( X ) ) ) \qquad ( 1 )$$

$$A ( X ) V ( X ) = {∅}_{2} ( Q ( X ) {K ( X )}^{T} + {rab}^{p , t} ) V ( X ) \qquad ( 2 )$$

$$Y ( X ) = {f}_{2} ( Norm ( A ( X ) V ( X ) ) ⊙ U ( X ) ) \qquad ( 3 )$$

The HSTU encoder 54 may adopt a pointwise aggregated attention mechanism instead of softmax attention in transformers. This mechanism may be adopted based on two factors. First, in recommendations, the number of prior data points related to target serves as a strong feature indicating the intensity of user preferences, which may be difficult to capture after the softmax normalization. This may be important in predicting the intensity of engagement and the relative ordering of items. Second, while softmax activation may be considered robust to noise by construction, it may be less suited for non-stationary vocabularies in streaming settings. The pointwise aggregated attention mechanism is captured in equation (2) above.

In GRs, the length of user history sequences may follow a skewed distribution, leading to sparse input sequences, particularly in the settings with very long sequences. This sparsity can be leveraged to improve the efficiency of the encoder. To do so, an efficient attention kernel may be used for GPUs that fuses back-to-back GEMMs that also performs fully raggified attention computations to transform the attention computation into grouped GEMMs of various sizes.

Compared to transformers, the HSTU encoder 54 may employ a simplified and fully fused design that may reduce activation memory usage, e.g., by reducing the number of linear layers outside of attention, and by fusing computations into single operators (see equations (1) and (3) above). Such a design has been found to reduce activation memory usage.

The penultimate layer 96, denoted by HSTU Layer N−1 in FIG. 5, is obtained by the inference at block 52 to generate the propensity output 38. As shown in FIG. 3, the propensity output 38 is determined using the propensity model 36 used at block 52. That is, the event(s) and probabilities of those events occurring that are presented at the output of the penultimate layer 96 are used as inputs to the inference operation at block 52. The inference at block 52 uses a model that has been trained to determine the propensity towards or probability of an action being taken. That action may be a system or user action and whether that action occurs within a period of time.

While the traditional HSTU output (i.e., from Layer N) is a next token prediction, other use cases may require other recommendations or predictions, such as the propensity towards, or probability of, an action occurring. For example, as noted above, a use case may be tasked with predicting the probability of an event occurring during a subsequent time window, not necessarily which event is next.

To satisfy this type of use case, the next-token prediction layer (e.g., the last HSTU layer 98) may be swapped with or otherwise bypassed to the inference stage 52 using the propensity model 36 that has been trained for the desired prediction or recommendation, e.g., using an MLP+Sigmoid to estimate product adoption (or other action) probabilities. That is, the output from the penultimate HSTU layer 96 may be used with the propensity model 36 that is trained for the particular application. The loss calculations may be based on a Boolean adoption target. In one example the solution may use sequences of events 30 to train the generative recommender 34 with, for example, 7 HSTU layers. In normal use of such an HSTU model 50, the output of the 6th layer would be used by the 7th layer to determine the final result, namely the predicted or recommended next event. In the configuration shown in FIG. 5, the propensity engine 20 is configured to take the output of that 6th (or penultimate) layer 96 and feed that into the propensity model 36 (e.g., MLP). The output of the penultimate layer 96 may provide a number of events and probabilities of those being the next event. This information may be used by the propensity model 36 to determine the propensity towards, or probability of, a certain action being taken, e.g., within a period or window of time.

The HSTU encoder 34, whether the side features 46 are embedded or not, may thus provide the inputs to the next model (i.e., the propensity model 36) that is trained for the desired output. The HSTU encoder 34 accepts the sequence of events 30 as an input and determines what is important, which enhances the ability for the next model (i.e. the propensity model 36) to be trained for the desired outcome. In this way, the need to have machine learning engineers construct models to do a single task, which may change over time, can be avoided.

Moreover, when combined with the side features 46 component described herein, the side feature embeddings may be added at any point where the input sequence of events 30 is obtained.

FIG. 6 illustrates an example of the event and side feature embedding 32 that may be performed in both HSTU model training 44 and inference using the HSTU encoder 54. The input sequence of events 30 is subjected to event feature embedding 102. Moreover, the side features 46 may be subjected to a side feature embedding 104, e.g., a linear transformation. The event and side feature embeddings are then combined to create entity embeddings 106 (e.g., user embeddings) that take into account both the events 30 and the side features 46.

In an example, events 30 dimensionally represented by B×N×1, when embedded, results in B×N×D. For the side features 46, dimensionally represented by B×N×S_in (e.g., where S_in is 1 in this example), the side feature embedding 104 results in B×N×S_out. When combined using concatenation, for example, the entity embeddings 106 result in B×N×D+S_out.

The side features 46 may be represented using integers with a given event 30. In some cases, the value for the side feature 46 may be determined by generating an embedding vector relative to the given event 30. It can be appreciated that the side features 46 may be augmented with the events 30 by adding fields into a set of bits (bit field). For example, three features or side features 46 for an event 30, namely, A, B, C, may be combined in bit fields as integers:
event.featureA.featureB.featureC

The embeddings may map to fixed sized results to avoid the need to know a priori what features may be relevant to any given event 30. The side features 46 enhance the embeddings to avoid losing the details of the event 30, which may be considered important for a given application 18, 24.

The side features 46 may be generated for many types of logged events 30 to capture such details. Examples of events 30 may include, without limitation, impression counts, view counts, click counts, support events in a ticket, email open, email reply, topic in an email, etc. Events 30 that do not include a relevant side feature 46 may be given a fixed value, e.g., −1.

The side features 46 provide the HSTU model training 44 or HSTU encoder 54 with a bit fielded or otherwise enhanced embedding that allows the HSTU training/encoder 44, 54 to get enough information to avoid the need to have an a priori list of the event details, which allows changes to events 30 to occur over time. Embeddings in this case may be numerical representations of information about the event 30. For example, the embedding of a received email may be computed by using a sentence encoder such as BERT to represent the semantic meaning of the topic of the email subject and or body. In another example, metadata from the email header may be computed into an embedding. Similarly, text within a support ticket, and/or other fields of the support ticket such as severity, metadata or statistics about the support ticket, and what caused the ticket to be created, opened or closed may be used to generate an embedding.

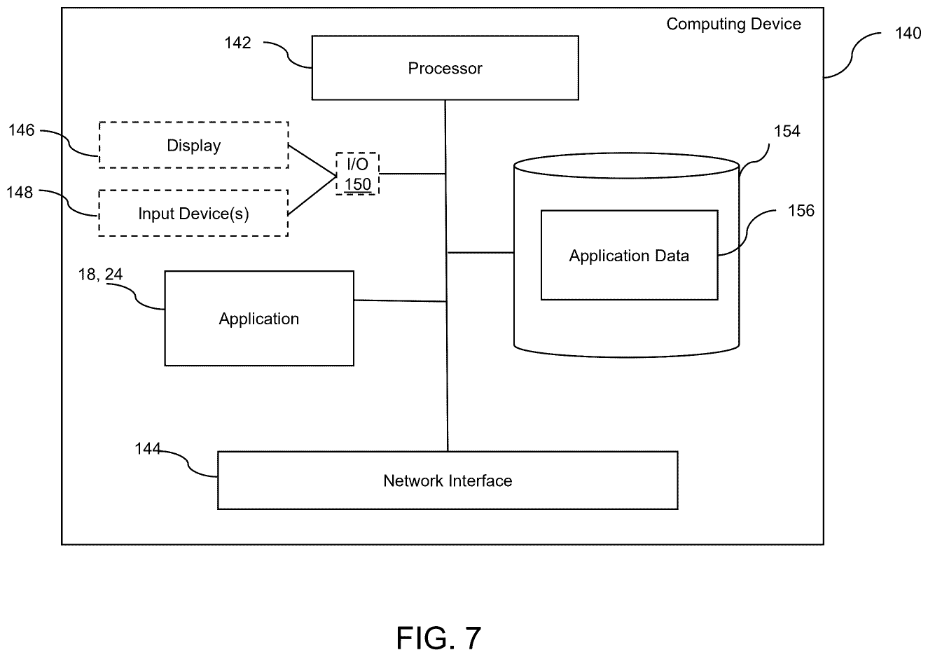

FIG. 7 shows an example of a computing device 140 which may be utilized by any one or more of the entities shown in FIG. 1, for example, the client device 12 and/or the server device 14.

In this example, the computing device 140 includes one or more processors 142 (e.g., a microprocessor, microcontroller, embedded processor, digital signal processor (DSP), central processing unit (CPU), media processor, graphics processing unit (GPU) or other hardware-based processing units) and one or more network interfaces 144 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 140 may also include an application 18, 24 (e.g., according to a device type), a data store 154, and application data 156.

The data store 154 may represent a database or library or other computer-readable medium configured to store data and permit retrieval of data by the computing device 140. The data store 154 may be read-only or may permit modifications to the data. The data store 154 may also store both read-only and write accessible data in the same memory allocation. In this example, the data store 154 stores the application data 156 for the application 18, 24 that is configured to be executed by the computing device 140 for a particular role or purpose.

While not delineated in FIG. 7, the computing device 140 includes at least one memory or memory device that can include a tangible and non-transitory computer-readable medium having stored therein computer programs, sets of instructions, code, or data to be executed by processor(s) 142. The processor(s) 142 and network interface(s) 144 are connected to each other via a data bus or other communication backbone to enable components of the computing device 140 to operate together as described herein. FIG. 7 illustrates examples of modules and applications stored in memory on the computing device 140 and executed by the processor(s) 142.

It can be appreciated that any of the modules and applications shown in FIG. 7 may be hosted externally and may be available to the computing device 140, e.g., via a network interface 144. The data store 154 in this example stores, among other things, the application data 156 that can be accessed and utilized by the application 18, 24. The data store 154 may additionally store one or more software functions or routines in a cache or in other types of memory.

As shown in FIG. 7, the computing device 140 may, optionally (e.g., when configured as a client device 12), include a display 146 and one or more input device(s) 148 that may be utilized via an input/output (I/O) module 150. That is, such components may be omitted when the computing device 140 does not interact with a user.

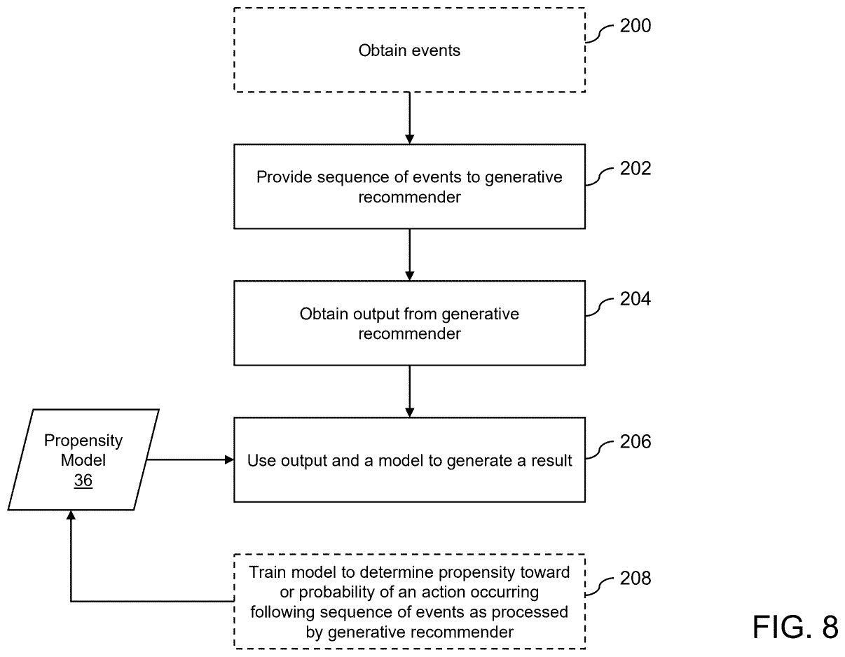

FIG. 8 is a flow chart illustrating example operations performed in using a generative recommender 34 to determine a propensity towards or probability of actions being taken. At block 202, the sequence of events 30 may be provided to the generative recommender 34, e.g., as shown in FIG. 3. Optionally, the events 30 may be obtained by the generative recommender 34 or some other function or tool utilized by the propensity engine 20 at block 200.

At block 204, an output from the generative recommender 34 is obtained, e.g., as illustrated in FIG. 5. At block 206, the output and a model (e.g., propensity model 36) is used to generate a result, e.g., by generating an inference using the propensity model 36 and determining a propensity output 38 for the application 18, 24 as illustrated in FIG. 3.

Optionally, at block 208, the model to be used at block 206 (e.g., propensity model 36), may have been trained to determine the propensity toward or probability of an action occurring following a sequence of the events 30 as processed by the generative recommender 34.

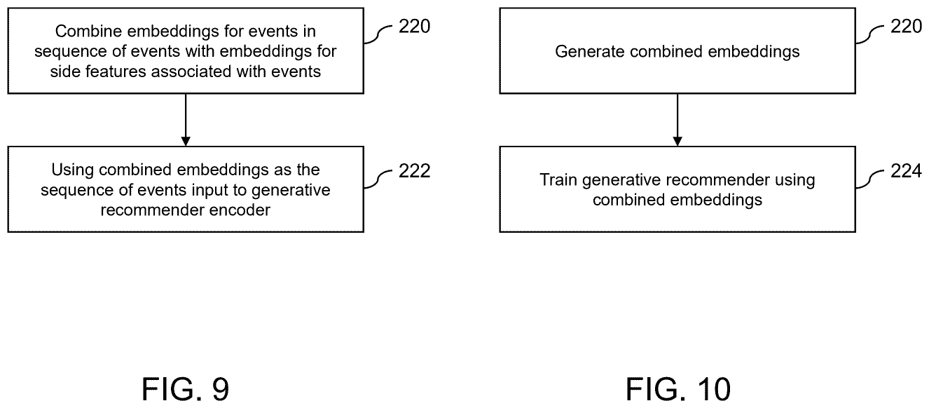

FIG. 9 is a flow chart illustrating example operations performed in generating combined embeddings 106 using side features 46, e.g., as shown in FIG. 6. At block 220, event feature embeddings 102 for events 30 in the sequence of events 30 may be combined with side feature embeddings 104 associated with the events 30 in the sequence of events 30. At block 222, the combined embeddings 106 may be used as the sequence of events 30 input to the encoder 54 used by the generative recommender 34, e.g., as shown in FIG. 3.

FIG. 10 is a flow chart illustrating example operations performed in training a generative recommender 34 using combined embeddings. At block 220, the combined embeddings 106 (e.g., as shown in FIG. 9) are generated. At block 224, the generative recommender 34 may be trained using the combined embeddings 106.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information, and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
providing a sequence of events to a generative recommender;
obtaining an output from the generative recommender; and
using the output and a model to generate a result, the model having been trained to determine a propensity towards, or probability of, an action occurring following the sequence of events as processed by the generative recommender.

2. The method of claim 1, wherein the generative recommender comprises a hierarchical sequential transduction unit (HSTU).

3. The method of claim 2, wherein the HSTU comprises a plurality of sequential transducers and an attention mechanism.

4. The method of claim 3, wherein the HSTU comprises multiple layers connected by residual connectors.

5. The method of claim 4, wherein the multiple layers are identical.

6. The method of claim 3, wherein the sequential transducers comprise a pointwise projection sub-layer, a spatial aggregation sub-layer, and a pointwise transformation sub-layer, and wherein the output is obtained from the pointwise transformation sub-layer of a penultimate layer of the plurality of layers.

7. The method of claim 6, wherein an output obtained from a final layer of the plurality of layers is used to predict a next event.

8. The method of claim 1, wherein the model is a multilayer perceptron (MLP).

9. The method of claim 8, wherein the MLP is trained to predict the propensity towards, or probability of, the action based on the output obtained from a penultimate layer of the generative recommender.

10. The method of claim 1, wherein embeddings for the events in the sequence of events are combined with embeddings for side features associated with the events.

11. The method of claim 10, further comprising using the combined embeddings as the sequence of events.

12. The method of claim 10, wherein the side features are subjected to a linear transformation and combined with the embeddings for the events.

13. The method of claim 12, wherein transformed side features are concatenated with the embeddings for the events, to create user embeddings.

14. The method of claim 10, wherein the side features are embedded with the embeddings for the events, using fields in a sequence of bits associated with the event.

15. The method of claim 10, wherein the side features are used in training the generative recommender.

16. The method of claim 10, wherein the side features embed a type of event to distinguish between different types of a same event.

17. The method of claim 1, further comprising presenting the propensity towards, or probability of the action being taken.

18. The method of claim 17, wherein the propensity towards, or probability of, the action being taken is associated with a window of time.

19. The method of claim 18, wherein the model presents the propensity towards, or probability of, the action occurring within the window of time.

20. A computer system comprising:
a processor; and
a memory, the memory storing processor executable instructions that, when executed by the processor, cause the computer system to:
provide a sequence of events to a generative recommender;
obtain an output from the generative recommender; and
use the output and a model to generate a result, the model having been trained to determine a propensity towards, or probability of, an action occurring following the sequence of events as processed by the generative recommender.

21. A computer-readable medium storing processor executable instructions that, when executed by a processor of a computer system, cause the computer system to:
provide a sequence of events to a generative recommender;
obtain an output from the generative recommender; and
use the output and a model to generate a result, the model having been trained to determine a propensity towards, or probability of, an action occurring following the sequence of events as processed by the generative recommender.
